(19) United States
(12) Patent Application Publication
(10) Pub. No.: US 2013/0267362 A1
(43) Pub. Date: Oct. 10, 2013

(54) Bicycle Transmission

(71) Applicants: Liviu Augustine Gheciu, Alpine, UT (US); Gerry F. O'melia, Salt Lake City, UT (US); Benjamin L. Wilson, Portland, OR (US); Michael E. Campenella, Salt Lake City, UT (US); Eric B. Morrison, Salt Lake City, UT (US)

(72) Inventors: Liviu Augustine Gheciu, Alpine, UT (US); Gerry F. O'melia, Salt Lake City, UT (US); Benjamin L. Wilson, Portland, OR (US); Michael E. Campenella, Salt Lake City, UT (US); Eric B. Morrison, Salt Lake City, UT (US)

(73) Assignee: UNIVERSITY OF UTAH RESEARCH FOUNDATION, Salt Lake City, UT (US)

(21) Appl. No.: 13/810,175

(22) PCT Filed: Jul. 14, 2011
(86) PCT No.: PCT/US2011/044067

§ 371 Date: May 17, 2013

Related U.S. Application Data
(60) Provisional application No. 61/364,506, filed on Jul. 15, 2010.

(51) Int. Cl. F16H 9/24

(52) U.S. Cl. CPC F16H 9/24
USPC 474/80; 474/164

(57) ABSTRACT

Embodiments are directed to bicycle drive trains, as well as methods and systems for changing gear ratios within the bicycle drive trains. A bicycle drive train includes a crank assembly, where the crank assembly is configured to rotate about an axis. The crank assembly defines a plane generally transverse to the axis. The crank assembly includes at least one driving gear in the plane that is of a first gear size. The crank assembly is also configured to selectively vary the size of the driving gear in the plane, so that the driving gear changes size while remaining positioned within the plane. The crank assembly may also be configured to include hinged gear segments that, when moved about their hinge, allow gear shifts along the same linear plane.

### CROSS-REFERENCE TO RELATED APPLICATIONS

This application claims priority to and the benefit of U.S. Provisional Patent Application No. 61/364,506, entitled “Bicycle Transmission”, filed on Jul. 15, 2010, which is incorporated herein by reference.

### BACKGROUND OF THE DISCLOSURE

1. The Field of the Disclosure

The present disclosure relates to bicycle components. More particularly, the present disclosure relates to bicycle transmissions, including front gear assemblies for bicycles.

2. The Relevant Technology

Many ideas have been proposed in relation to the bicycle gearing system; however, there is one standard design that has stood the test of time. In that design, the drive chain is moved from one sprocket to an adjacent sprocket to change the gear ratio. In this way, the rider is able to shift gears when the bike is moving at different rates. This design is highly efficient, has few moving parts, is relatively lightweight, and reasonably rugged. Despite all of the positive design traits of the traditional gear system, it has a few major flaws. One of the most pronounced disadvantages of the traditional gear system is that it is difficult to shift gears under load (e.g., when riding uphill).

When a rider attempts to shift while the chain is under load, a lateral side load is applied to the chain (e.g., using a derailleur). Chains are often designed to withstand large tensile forces, but due to other considerations (e.g., weight and size considerations, design simplicity, etc.) are often not designed to withstand large lateral forces. As a result, if the gears are shifted under significant loads, the chain can break or become wedged between the sprockets. The chain also experiences wear due to the misalignment between the rear cassette and front chainrings which can lead to premature failure.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein are directed to bicycle drive trains, as well as methods and systems for changing gear ratios within the bicycle drive trains. In one embodiment, a bicycle drive train includes a crank assembly, where the crank assembly is configured to rotate about an axis. The crank assembly defines a plane generally transverse to the axis. The crank assembly includes at least one driving gear in the plane that is of a first gear size. The crank assembly is also configured to selectively vary the size of the driving gear in the plane, so that the driving gear changes size while remaining positioned within the plane.

In another embodiment, a bicycle transmission is provided which includes a first chainring that is fixedly aligned in a first plane and has multiple teeth configured to engage links of a chain. The bicycle transmission also includes a second chainring that is a different size than the first chainring. The second chainring is selectively aligned in a second plane that is generally parallel to the first plane and has multiple angularly offset gear segments that are movably attached to a crank assembly. Each of the segments has one or more teeth designed to engage the links of the chain. The bicycle transmission further includes a shifter proximate the second chainring. The shifter is designed to move each angularly offset gear segment independent of the other angularly offset gear segments of the second chainring. The shifter is designed to move the angularly offset gear segments from the second plane to the first plane, so that the chain is transferred from the first chainring to the second chainring while remaining in substantially the same plane.

In yet another embodiment, a method is provided for changing a gear ratio. The method includes engaging a chain with a first gear, where the first gear and the chain are substantially aligned within a first plane. The first gear is axially offset from a second gear that is in a second plane generally parallel to the first plane. The second gear includes multiple angularly offset gear segments that are movably attached to a crank assembly. The method further includes receiving an actuation signal that represents a request for a gear ratio change, and, in response to the actuation signal, sequentially moving each angularly offset gear segment from the second plane to the first plane, thereby moving the angularly offset gear segments of the second gear into the first plane. Moving the angularly offset gear segments of the second gear into the first plane causes the chain to engage the second gear rather than the first gear, thereby producing the requested gear ratio change.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present disclosure, a more particular description will be rendered by reference to specific examples which are illustrated in the appended drawings. It is appreciated that these drawings depict only typical examples and are therefore not to be considered limiting of the scope of the present disclosure. Examples will be described and explained with additional specificity and detail through the use of the accompanying drawings in which:

FIG. 1A illustrates a bicycle transmission that includes a drive train composed at least partially of a crank assembly and a front shifter, according to one example embodiment of the present disclosure;

FIG. 1B illustrates an isometric view of the crank assembly of FIG. 1A;

FIG. 2 illustrates an exploded view of the example crank assembly of FIG. 1B;

FIG. 3A illustrates a rear view of the example crank assembly of FIGS. 1A and 1B, in which an inner chainring and an outer chainring are in separate but parallel planes;

FIG. 3B illustrates a side view of the example crank assembly of FIGS. 1A and 1B, in which a chain is engaged with the inner chainring;

FIG. 4A illustrates a rear view of the example crank assembly of FIGS. 1A and 1B, in which an outer chainring is partially aligned with a plane in which an inner chainring is situated;

FIG. 4B illustrates a side view of the example crank assembly of FIGS. 1A and 1B, in which the outer chainring is at least partially transitioning into engagement with the chain;

FIG. 5 illustrates a side view of the example crank assembly of FIGS. 1A and 1B, in which the chain is engaged with the outer chainring;

FIG. 6 schematically illustrates a bicycle drive train having a chain around at least a portion of front and back sprockets, in which an unloaded portion of the front sprocket is designated as a free zone;

FIG. 7 illustrates an exploded view of the example front shifter of FIG. 1A;

FIG. 8 illustrates a side view of an example crank case having multiple hinged gear segments.

FIG. 9 illustrates a cross-sectional view of the crank case with the hinged gear segments.

FIG. 10 illustrates method steps for changing a gear ratio.

Together with the following description, the figures demonstrate non-limiting features of exemplary devices, systems, assemblies, and methods. The thickness, scale, and other configuration of components can be exaggerated or otherwise modified in the figures for clarity, and should therefore not be taken to be limiting and required for all embodiments. The same reference numerals in different drawings may represent similar, though not necessarily identical, elements.

### DETAILED DESCRIPTION

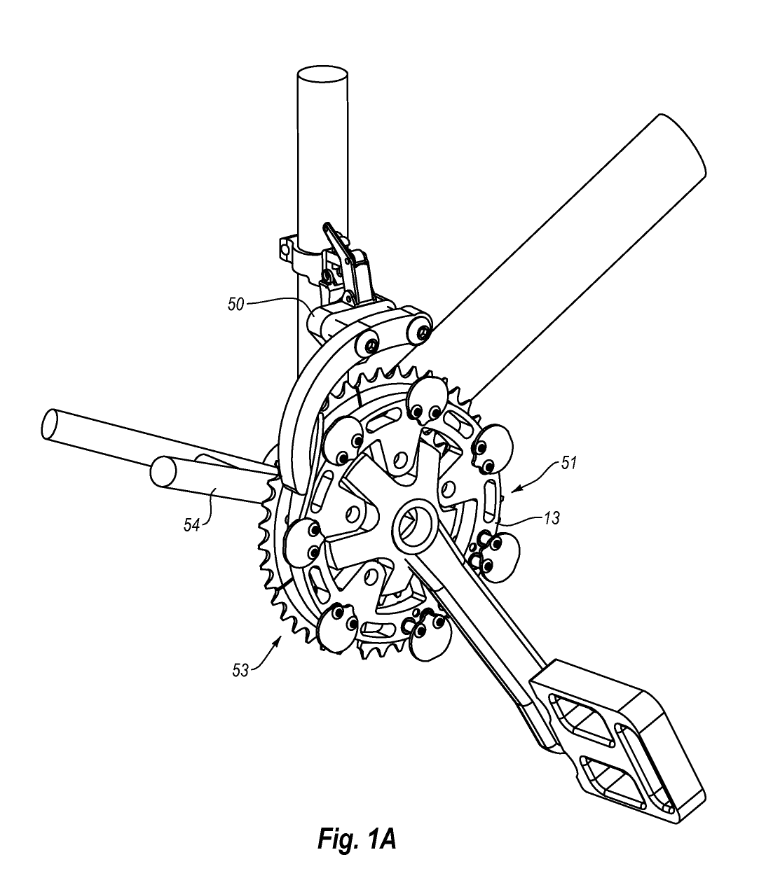

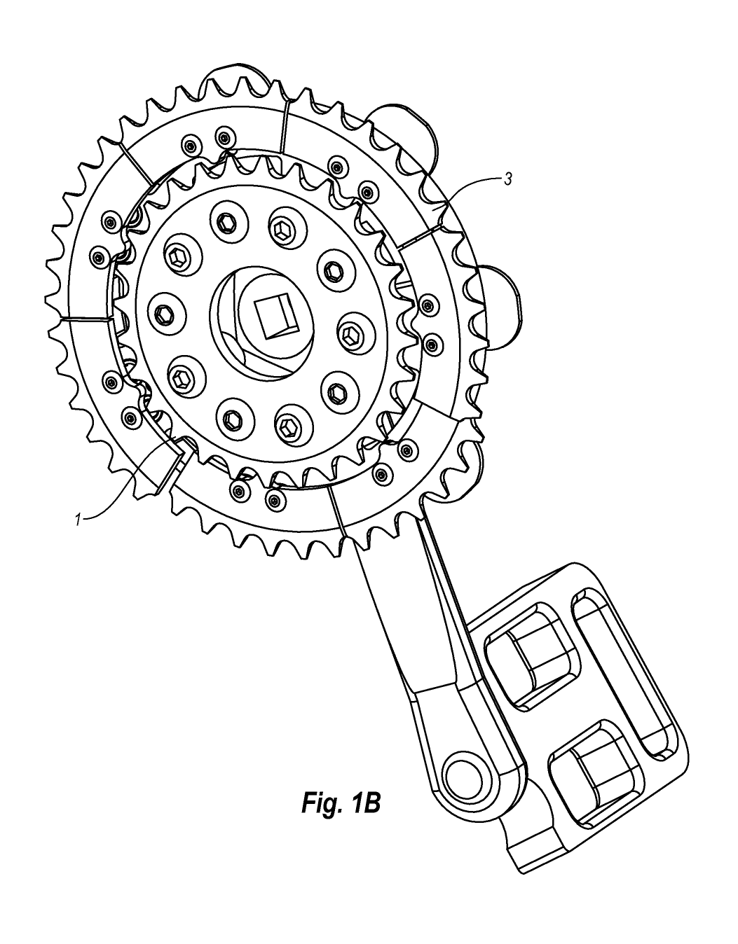

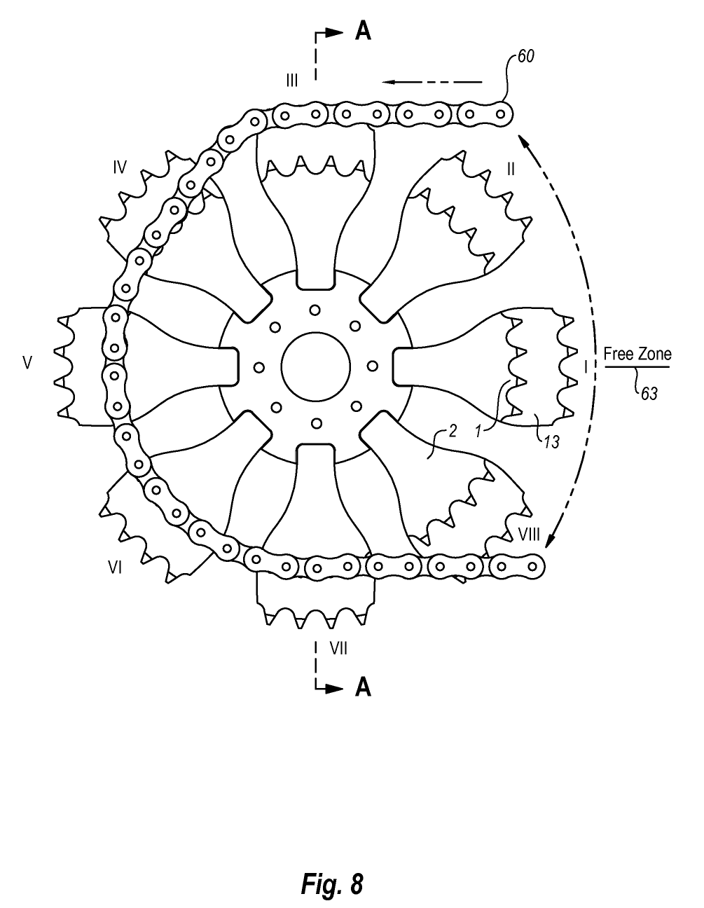

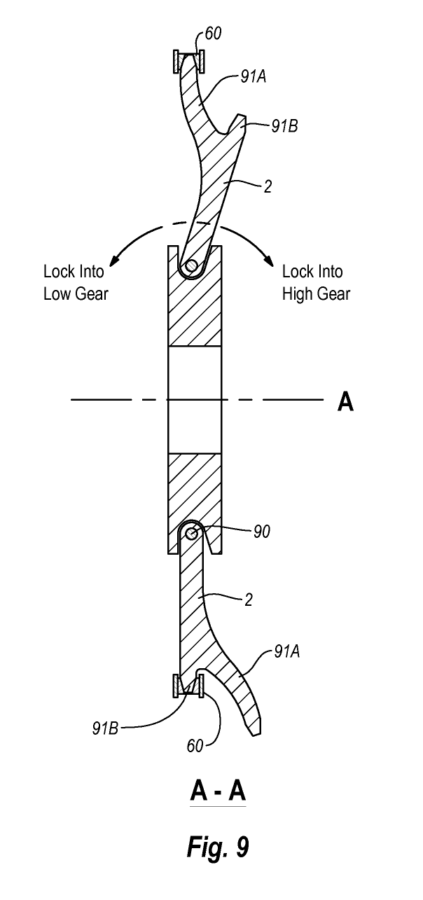

A bicycle transmission is provided herein that generally includes a drive train including a front shifting assembly. The front shifting assembly may include a front shifter and a crank assembly. The crank assembly and front shifter may be configured to cooperate to minimize—and potentially eliminate—lateral movement of a chain operating with the crank assembly as the crank assembly shifts gears and the transmission changes gear ratios. In at least one example, such as that shown in FIGS. 1A-5, gears of varying size may be moved into engagement with the chain to minimize lateral movement of the chain. In other examples, including some of those shown in FIGS. 8 and 9, the size, shape, configuration, or other aspects of a gear, or any combination of the foregoing, may additionally or alternatively be varied to minimize lateral movement of the chain or the lateral force needed to perform a gear shift.

For ease of reference, an example will first be described in which one or more gears are moved into and out of engagement with the chain. A bicycle will first be described generally to provide context for the operation of the drive train, followed by a more detailed discussion of one bicycle transmission. For ease of reference, the gear engaged with the chain will be described as a driving gear. Accordingly, in the case of a front shifting assembly having a plurality of gears, the driving gear may change according to which gear engages the chain. The gear size of the driving gear may then depend of the size of the gear then engaged with the chain. In other embodiments, the gear engaged with the chain may be a driven gear. Accordingly, no inference should be taken from the disclosure herein that necessarily requires that any engaged gear either drive or be driven by a chain or other member. Additionally, gears that connect to the chain may be referred to herein as chainrings as the illustrated embodiment includes a gear that operates in connection with a chain. In other embodiments, as described herein, a chain may be replaced by gearing, belts, or other elements, such that a chainring should be interpreted to include numerous types of sprockets, gears, or other driving or driven members.

FIG. 1A illustrates components of an example bicycle that may generally include a bicycle frame 54, wheels (not shown) and a drive train 53, among other components. The frame generally provides a platform for the bicycle transmission to allow the transmission drive train to transfer motive power generated by a user to a rear wheel. The power transferred to the rear wheel then propels the bicycle forward.

In the example illustrated in FIGS. 1A and 1B, the drive train of the bicycle transmission may include a crank assembly 51 and a front shifter 50. The drive train may also include a drive coupler. For ease of reference, a drive coupler may be referred to herein as a chain, although it will be appreciated that a chain is merely one type of suitable drive coupler. For example, a drive coupler may additionally or alternatively be or include a belt, gear train, or any other element capable of coupling a crank assembly to a rear wheel or rear wheel assembly, as well as combinations of the foregoing. In some examples, the chain is coupled to the rear wheel by way of a cog or cassette, though it will be appreciated the chain can be coupled to the rear wheel in any desired manner. A discussion of the shifting of the chain between cogs on the rear wheel will be omitted to avoid unnecessarily obscuring aspects of the bicycle transmission, drive train, crank assembly, and front shifter described herein.

The output of the crank assembly may depend, at least in part, on the size of the gear driving the chain. The size of the gear driving the chain may be varied in any suitable manner, and multiple gears of different sizes may be used to selectively drive the chain. The size of the gear driving the chain will be described herein as being changed by selectively moving chainrings having different diameters into engagement with the chain, as shown in FIG. 1B.

In at least one example embodiment, the front shifter 50 is configured to selectively transition the chainrings into and out of engagement with the chain. Transitioning the engagement of the chain to the different chainrings may also occur while the chain remains substantially within a single plane. Such a configuration may allow the front shifter to make changes to the crank assembly while under load and while minimizing lateral forces on the chain. Minimizing lateral forces on the chain may allow a rider to apply a relatively large load while shifting, and while reducing the risk of inadvertently breaking the chain, a derailleur, or one or more gears coupled to the chain. The configuration of an example crank assembly will now be discussed in more detail, followed by a discussion of the operation of an example front shifter.

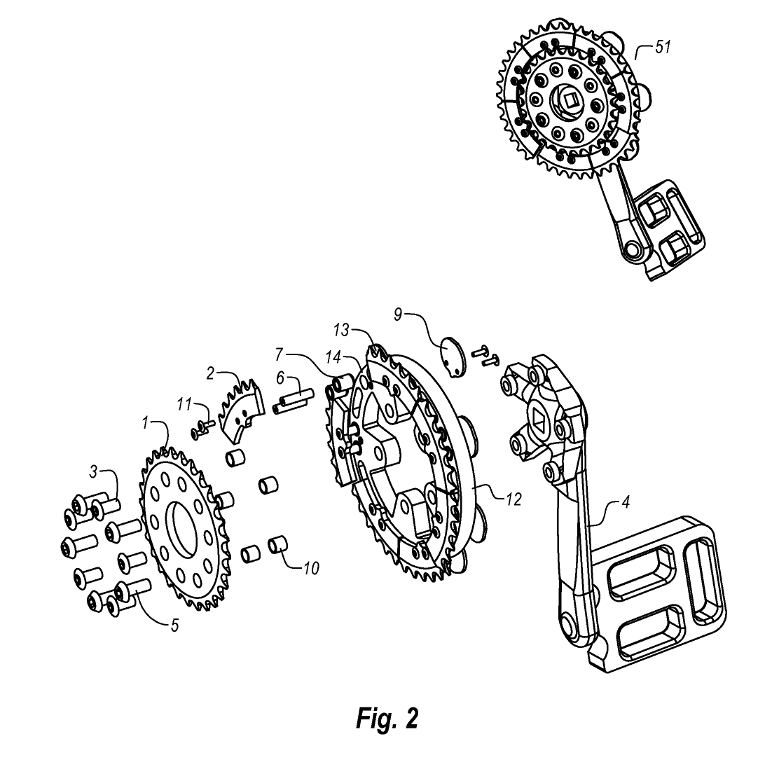

FIG. 2 illustrates an exploded perspective view of the crank assembly 51 in FIGS. 1A and 1B. As illustrated in FIG. 2, the crank assembly may generally include a crank arm 4, a support disk 12, and a plurality of chainrings. The plurality of chainrings may include, in this example, an inner chainring 1 and an outer chainring 13. The designation of the respective chainrings 1, 13 as inner and outer are for ease of reference only and it will be appreciated that the movement and position of the inner chainring 1 and the outer chainring 13 may be reversed or changed as desired. Further, additional or other chainrings, including middle chainrings, may also be included in some embodiments. For instance, another exemplary embodiment may include three chainrings, including chainring 1, chainring 13, and a third chainring. The third chainring may be similar to chainring 13 in structure and function (as chainring 13 is described below) except that the third chainring may be larger or smaller than chainring 13 so that the third chainring may be selectively positioned around the outer circumference of chainring 13 or between chainrings 1 and 13 (e.g., so that chainring 1, chainring 13, and the third chainring are generally concentric). In such an embodiment, chainring 13 and the third chainring may be selectively and individually moved in and out of the plane that chainring 1 lies in order to selectively change the gear ratio of the bicycle transmission. For ease of reference, the crank assembly in FIG. 2 will be described with reference to a rotational axis about which the crank arm 4 rotates. Movement of components parallel to the rotational axis will be described as axial movement.

Additionally, in at least one example, the inner chainring 1 may define or be oriented on or along a plane. Such a plane is, in some embodiments, generally transverse to the rotational axis of the crank arm 4. The support disk 12 may also define or be oriented on or along another plane. The plane of the support disk 12 may in some embodiments be generally transverse to the rotational axis of the crank arm 4. In at least one embodiment, the plane of the support disk 12 is axially offset from, but parallel to, the plane of the inner chainring 1.

In at least one example embodiment, the support disk 12 may be coupled to the crank arm 4. Coupling the support disk 12 to the crank arm 4, in some examples, serve to limit or eliminate axial movement of the support disk 12 with respect to the crank arm 4 and/or the inner chainring 1. For instance, the support disk 12 may have a fixed axial position relative to the crank arm 4 and/or the inner chainring 1. The particular manner of coupling the support disk 12 to the crank arm 4 may take any number of forms, and may be a direct or indirect coupling. In the illustrated example, the crank arm 4 includes a spider having a plurality of arms (five arms in the illustrated embodiment, although more or fewer may be used). The arms may have holes defined therein, and such holes may be oriented to correspond to a perimeter of a circle having a desired diameter. The support disk 12, in this embodiment, includes recesses defined therein. Such recesses may also generally be oriented to correspond to a perimeter of a circle the same diameter as the circle of the crank arm 4. In some embodiments, the recesses of the support disk 12 and/or the holes in the crank arm 4 may be threaded so as to form a bolt circle.

In the illustrated example, a circle having a similar diameter as those in the crank arm 4 and/or the support disk 12 may also be defined in the inner chainring 1. Spacers 10 may, in some embodiments, be positioned between the support disk 12 and the inner chainring 1, thereby allowing the support disk 12 and the inner chainring 1 to remain in axially offset, but parallel planes. The size of the spacers 10 may vary in any suitable manner. In one embodiment, the spacers 10 may be between about five and about fifteen millimeters in length. At such lengths, the axial movement of the outer chainring 13 may be minimized such that a chain may efficiently step between the inner chainring 1 and the outer chainring 13.

Fasteners 3 may extend through holes in the inner chainring 1. For instance, in the illustrated embodiment, the fasteners 3 may extend through the spacers 10, through the support disk 12, and into the crank arm 4. For instance, the fasteners 3 may include bolts that can be threaded into threads in the holds on the crank arm 4, although in other embodiments, cotter pins, rivets, clamps, adhesives, welding, other types of fasteners or fastening mechanisms, or combinations of the foregoing may be used. In at least some embodiments, the fasteners 3 secure both the support disk 12 and the inner chainring 1 to the crank arm 4. Further, as noted above, the spacers 10 may position the inner chainring 1 at a desired axial offset with respect to the support disk 12. Accordingly, the inner chainring 1 may, in some embodiments, be maintained at a stationary axial position relative to the support disk 12. In other words, the inner chainring 1 may be fixedly aligned within a first plane. In other embodiments, however, the inner chainring 1 may be selectively movable in an axial direction so that the inner chainring 1 may be selectively moved into and out of alignment with the first plane.

The outer chainring 13 of FIG. 2 may include a plurality of segment sub-assemblies that collectively form the outer chainring 13. Each of the segment subassemblies may be coupled to the support disk 12. In at least some embodiments, each segment subassembly may be configured in a manner that allows independent, axial translation of a gear segment 2 with respect to other gear segments 2 of the outer chainring 13 and/or the support disk 12. For instance, as shown in FIG. 2, the support disk 12 may include a plurality of guide holes 14. In some embodiments, a plurality of bushings 7 may be press fit or otherwise used in connection with the plurality of guide holes 14.

For example, the plurality of bushings 7 may include oil impregnated bronze bushings that are positioned within the guide holes 14 as desired, although other types of bushings may be used. In other embodiments, bearings, coatings, or other friction-reducing components or finishes, or any combination of the foregoing, may be used in connection with the support disk 12. Further, while the illustrated embodiment depicts seven gear segments 2, each of which correspond to two guide holes 14 and two bushings 7, it should be appreciated that this is merely exemplary. In other embodiments, there may be one bushing 7 and/or guide hole 14 per gear segment 2, or more than two bushings 7 and/or guide holes 14 per gear segment 2. Further, more or fewer than seven gear segments 2 may additionally or alternatively be spaced around the perimeter of the outer chainring 13.

In the illustrated example, each segment subassembly may include two guide shafts 6, although more or fewer guide shafts 6 may be used. The guide shafts 6 may be configured to translate axially within an associated bushing 7. Each gear segment 2 of a segment subassembly may further be coupled proximate one end of the guide shaft 6 and a stop plate 9 may be coupled proximate an opposing end of the guide shaft 6. Such a configuration may allow the gear segment 2 and the stop plate 9 to constrain or limit axial movement within the segment subassembly.

For example, as the guide shafts 6 slide or otherwise move within the bushings 7, a gear segment 2 may come into contact with an inner surface of the support disk 12, thereby limiting or otherwise constraining further axial movement of the segment subassembly in one axial direction (e.g., outward axial movement). As the guide shafts 6 move in an opposing direction, the stop plate 9 may engage against the outer surface of the support disk 12, thereby limiting further axial movement in the opposing direction (e.g., inward axial movement). It should be appreciated in view of the disclosure herein that limiting the axial movement of a segment subassembly may also be performed in other manners. For instance, one or more other stop plates or other elements may be used to constrain movement such that it is not necessary that the stop plate 9 and/or the gear segment 2 actually engage the support disk 12 to limit axial movement within a segment subassembly.

Axial movement of the segment subassemblies may allow at least portions of the segment subassemblies to transition between a plurality of different states and/or positions. For instance, in one embodiment, at least the gear segments 2 of the segment subassemblies may transition from an aligned state to an unaligned state, and vice versa. In one example embodiment, the aligned state may correspond to an axial position in which a gear segment 2 is aligned with the inner chainring 1, while an unaligned state may correspond to an axial position in which a gear segment 2 is not aligned with the inner chainring 1.

For instance, in an aligned position or state, the inner chainring 1 and a gear segment 2 may be positioned substantially within the same plane, rather than in separate planes (e.g., axially offset, parallel planes). In contrast, in an unaligned state or position, the inner chainring 1 and a gear segment 2 may be positioned within separate planes (e.g., axially offset, parallel planes). As described in greater detail herein, one or more of the plurality of gear segments 2 may be in an aligned state while other one or more of the plurality of gear segments 2 may be in an unaligned state. For instance, FIG. 1B shows an example embodiment in which five gear segments 2 are generally aligned with an inner chainring 1 while two gear segments 2 are axially offset from the inner chainring 1.

With continued reference to FIG. 2, the aligned and/or unaligned states or positions of the gear segments 2 may correspond to limits on the axial translation within the segment subassemblies. For instance, in one embodiment, a gear segment 2 and corresponding segment subassembly may be in the aligned state or position when the stop plate 9 is in contact with the outer surface of the support disk 12, or at some other position of the stop plate 9 relative to the support disk 12 that corresponds to a limit or constraint on the axial translation within the segment subassembly. A gear segment 2 and corresponding segment subassembly may be in an unaligned state or position when the gear segment 2 is in contact with, or is proximate to, the support disk 12. In the unaligned state or position, the stop plate 9 may be at an axial position relative to the support disk 12 that restricts further outward axial movement, but allows inward axial movement to allow a segment subassembly to transition to an aligned state or position.

In at least some embodiments, each segment subassembly may move or otherwise transition between the aligned state/position and the unaligned state/position, and/or may be selectively maintained in the respective aligned or unaligned state/position. In some embodiments, one or more, and possibly all segment subassemblies may selectively transition between aligned/unaligned states independent of other segment subassemblies.

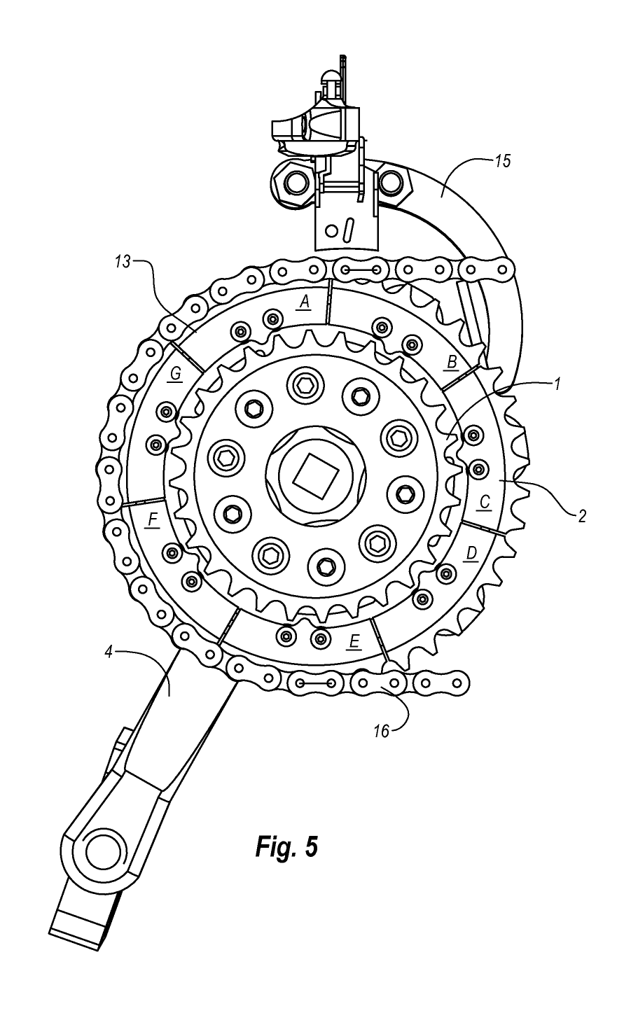

Thus, in some embodiments, one or more (and possibly each) segment subassembly may transition at a different time or otherwise transition or move independent of other of the segment subassemblies. Maintaining segment subassemblies in the aligned and unaligned states/positions will first be discussed with respect to one example configuration of a crank assembly. Thereafter, the movement of the gear segments 2 between the aligned and unaligned positions will be described with respect to the front shifter disclosed herein. To facilitate movement or other transitioning of the gear segments 2 to an aligned position, the gear segments 2 may be sized and configured to overlap the inner chainring 1. For instance, in FIG. 5, it can be seen that the gear segments 2 are sized such that as they move into alignment with the inner chainring 1, the inner chainring 1 does not necessarily interfere with the rotation of the gear segments 2, or the axial movement of the gear segments 2.

In at least one example embodiment, a biasing force may be used to maintain all or portions of the segment assemblies in aligned and/or unaligned states or positions. In one example embodiment, the biasing force may include or make use of magnetic attraction. For example, one or more magnets may be coupled to or incorporated within the support disk 12. In particular, one or more magnets (e.g., a neodymium, samarium cobalt, alnico, ceramic, or ferrite magnets) may be positioned on the support disk 12, and/or within openings defined in the support disk 12. For ease of reference, only one segment subassembly will be discussed, although it will be appreciated that the discussion may be applicable to each of the segment subassemblies.

A magnet may act as a bi-stable linear mechanism to maintain each segment subassembly in a desired state or position. For instance, a magnet may exert a magnetic attraction force on a gear segment 2 and/or 1 stop plate 9. As a result, when the gear segment 2 is moved towards the aligned position or state as described previously, magnetic attraction may draw the stop plate 9 toward a magnet. As the stop plate 9 moves toward the magnet, the guide shaft 6 may move inwardly through the support disk 12 and/or bushings 7 until the stop plate 9 is in contact with the magnet and/or the outer surface of the support disk 12, or otherwise positioned such that the magnetic attractive force acts as a biasing force on the segment subassembly. The magnetic attraction between the stop plate 9 and the magnet may then act to maintain the segment subassembly in the aligned state or position by maintaining the stop plate 9 in close proximity to the magnet. The magnetic attraction or other biasing force may then maintain one or more of the segment subassemblies in the aligned state or position until a gear change is desired. Indeed, if a segment subassembly is bumped out of position (e.g., by riding on a bumpy road, hitting a hole in a trail, etc.), the magnetic attraction or other biasing force may pull the segment assembly back into its desired position.

Similarly, when the segment subassembly transitions towards the unaligned state or position described previously, magnetic attraction may act to move the gear segment 2 into contact with the support disk 12 and/or the magnet, or to otherwise maintain the gear segment 2 at a particular location relative to the support disk 12 and/or the magnet. In some embodiments, a mechanical force or actuator may be used to overcome the biasing force maintaining the stop plate 9 at a location corresponding to the unaligned state of the segment subassembly. For instance, a front shifter may exert an axially directed force that moves the segment subassembly in an outward axial direction, thereby overcoming the magnetic attraction force between the stop plate 9 and the magnet.

As all or a portion of the segment subassembly continues to move in an outward axial direction, the magnetic attraction forces between the gear segment 2 and the magnet may increase, thereby assisting in transitioning the segment subassembly to an unaligned state or position. The front shifter disclosed herein is merely one example of a device that can be used to facilitate transitioning the segment subassemblies between aligned and unaligned states/positions. Any suitable device or mechanism can be used to transition the segment subassemblies between aligned and unaligned states/positions, and/or to move the stop plate 9 or gear segment 2 into a position in which a magnet or other biasing mechanism can act on, or relative to, the stop plate 9 or the gear segment 2.

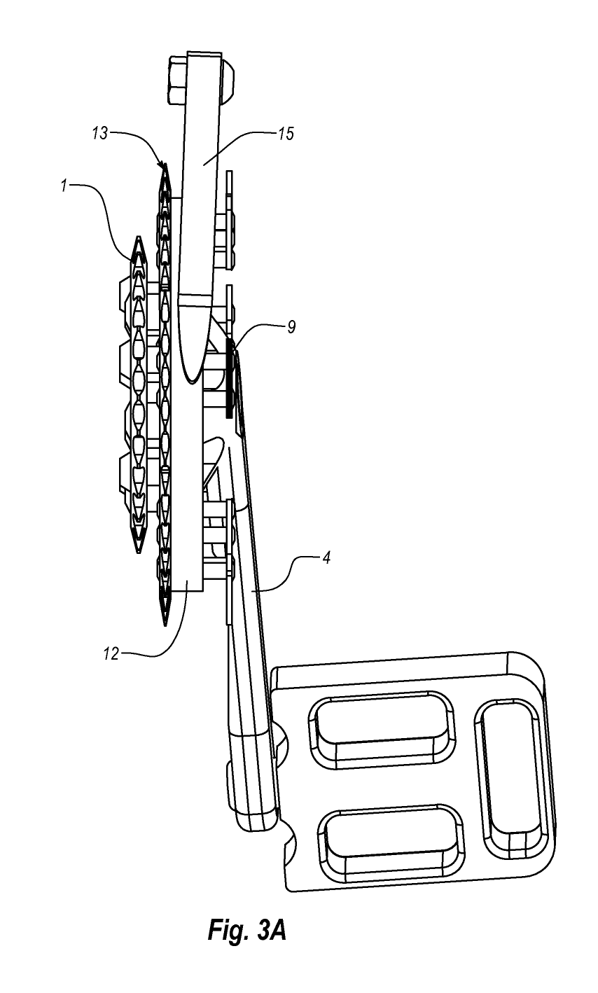

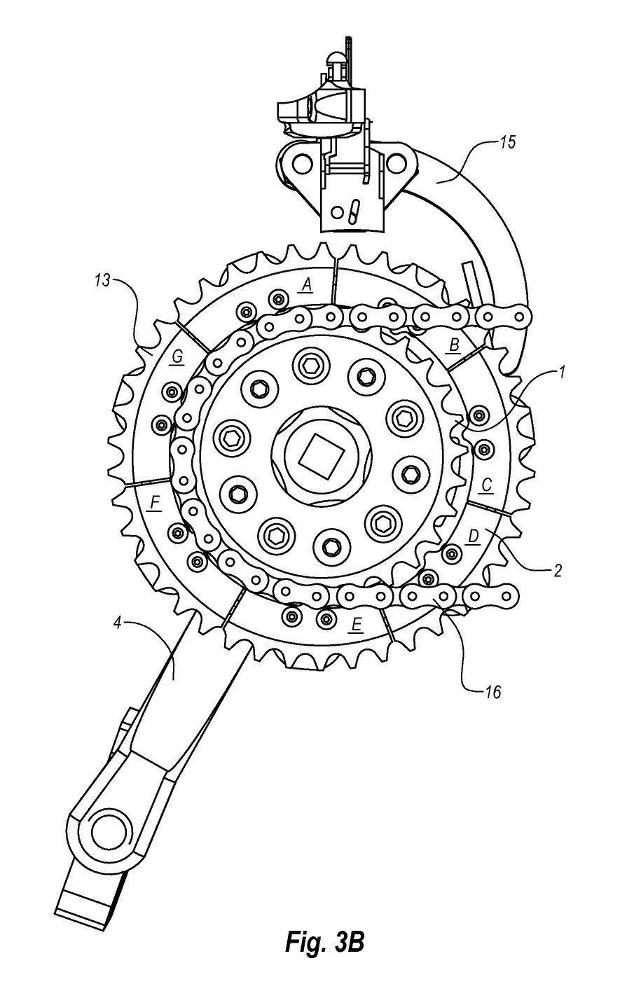

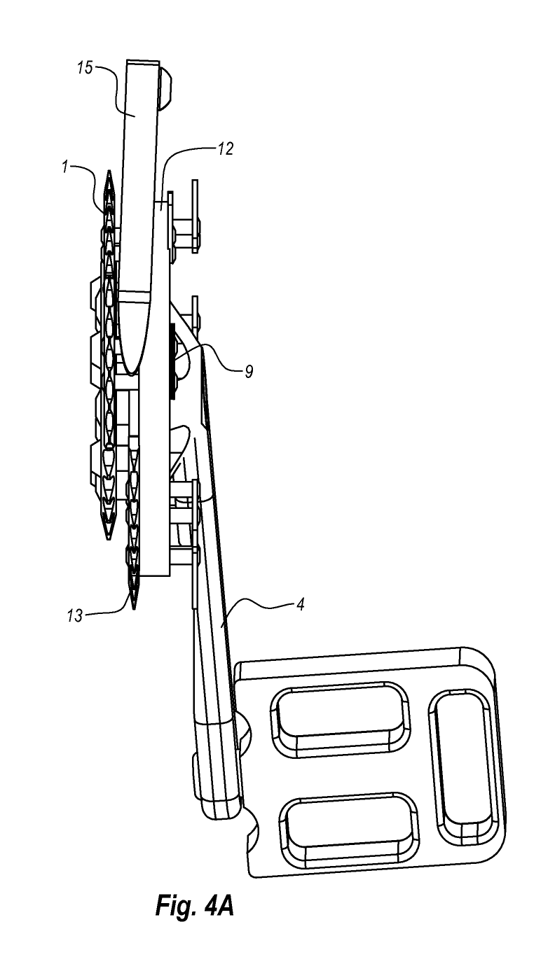

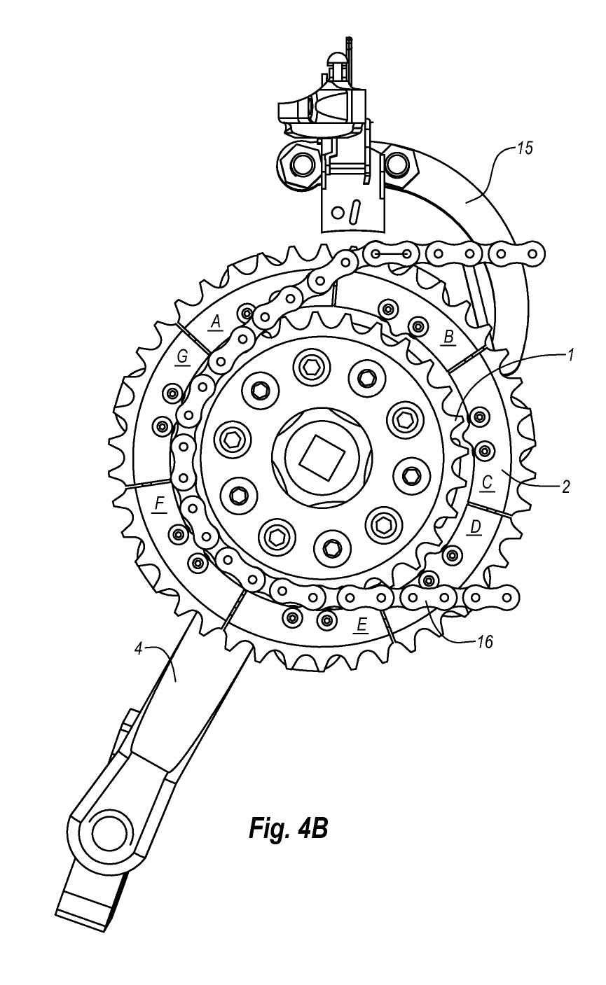

FIGS. 3A-5 illustrate the operation of a front shifter 15 in greater detail, including the use of the front shifter 15 to transition segment subassemblies between aligned and unaligned states or positions. FIG. 3A illustrates a crank assembly in which all gear segments forming the outer chainring 13 are in an unaligned position, such that the front shifter 15 is in a position maintaining the segment subassemblies in unaligned positions. FIG. 4A illustrates the front shifter 15 in position to move segment subassemblies to aligned positions or states, and shows at least one segment subassembly that has been moved to an aligned position or state. The position of a stop plate 9 of one segment subassembly in the aligned state or position is shaded for ease of reference. As the front shifter 15 moves a segment subassembly into an aligned position or state, a corresponding gear segment 2 may be positioned in line with the inner chainring 1 and the chain 16 (FIGS. 3B, 4B).

As will be appreciated in view of the disclosure herein, gear segments 2 may progressively be positioned in line with the chain 16 and the inner chainring 1, or drawn out of line with chain 16 and chainring 1. When the gear segments 2 are positioned in line with the chain 16 and the inner chainring 1, the chain 16 may pass around at least a portion of the perimeter of the outer chainring 13. If a gear change is desired, the gear segments 2 may be moved out of line with the chain 16 and the chainring 1, such that the chain 16 may pass around at least a portion of the perimeter of the inner chainring 1. In the illustrated embodiment, the chainring 1 has a smaller diameter than the chainring 13 so as to allow a gear ratio change to take effect in the bicycle transmission.

In FIG. 3B, each segment subassembly A-G may be in a fully unaligned position or state (e.g., such that all of gear segments 2 are axially offset from the plane in which the chainring 1 resides). In the unaligned position or state, each of the segment subassemblies A-G may be axially offset relative to the chain 16. As shown in FIG. 3B, as the chain 16 may be unobstructed by the segment subassemblies A-G, the chain 16 may engage directly with the inner chainring 1 to provide a first gear ratio within a corresponding bicycle transmission.

When a gear ratio change is desired, the segment subassemblies A-G may be selectively transitioned to a different state and/or position. For instance, in FIG. 4A, the front shifter 15 has been moved to an inner axial position relative to the position of the front shifter 15 in FIG. 3A. The front shifter 15 may engage or otherwise act upon the segment subassemblies A-G. For instance, as the segment subassemblies A-G rotate, they may cyclically pass by or along the front shifter 15. The front shifter 15 may cause each segment subassembly A-G to then transition to an aligned position or state by, for example, moving the gear segments 2 in an inward, axial direction. In FIG. 4B, for instance, segment subassemblies B and C may have been moved to an aligned position or state. As outer chainring 13 continues to rotate, segment subassemblies A and D-G may also transition to an aligned position or state. In FIG. 4B, the chain 16 has begun to transition gear ratios by extending around the perimeter of a portion of the outer chainring 13, and in FIG. 5, the chain 16 has fully changed gear ratios by extending fully around the outer chainring 13 rather than the inner chainring 1. The chain 16 may be moved from engagement with the outer chainring 13 to the inner chainring 1 by using an opposite process.

For instance, the front shifter 15 may cause the segment subassemblies A-G to successively move in an outward, axial direction, thereby causing the chain 16 to drop down or otherwise transition into engagement with the inner chainring 1. Since the chain 16 may remain aligned with the plane of the inner chainring 1 as the chain 16 moves between engagement with the inner chainring 1 and the outer chainring 13, a rider can continue to apply power without adding a lateral load to the chain 16 that may act to break the chain 16 or other components of a bicycle transmission.

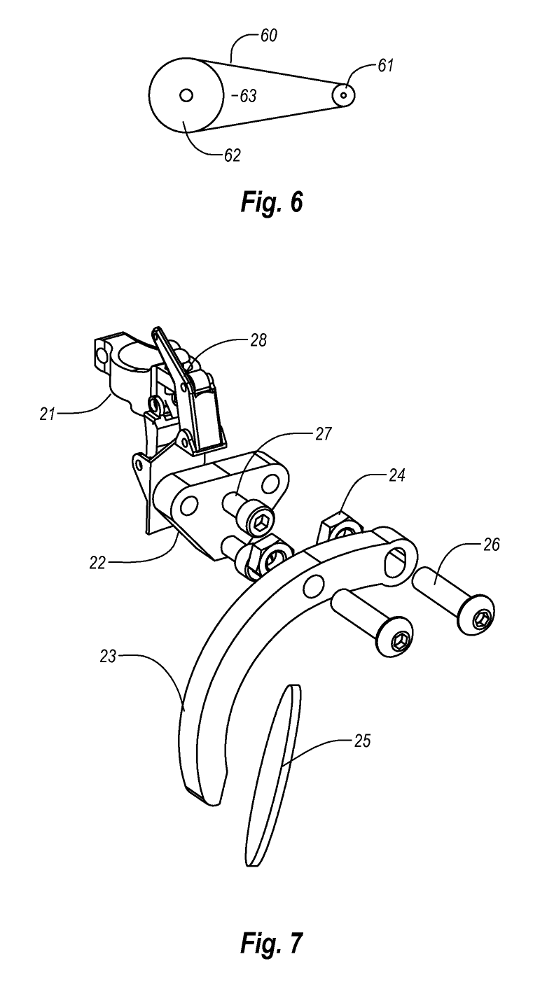

Additional disclosure of an example manner of transitioning between aligned and unaligned positions or states is described with additional reference to FIG. 6. More particularly, as the crank assembly rotates, the gear segments 2 also rotate. A free zone may be identified as a section of a chainring, gear, sprocket, sheave, or other driving member, or combination thereof, which is not engaged with the chain 16. For instance, in FIG. 6, an arc corresponding to approximately two-hundred forty degrees (substantially around front sprocket 62) is engaged with the chain, while an arc corresponding to about one-hundred twenty degrees is unengaged by the front sprocket (due to the chain's attachment to rear sprocket 61) and defines the free zone 63. The free zone may correspond to a smaller or larger arc in other embodiments. For example, the free zone may be an arc corresponding to approximately one-hundred eighty degrees, although the free zone may correspond to arcs of greater or lesser angle measurements. The free zone may also change size.

For example, in embodiments in which a bicycle transmission also uses a cassette on a rear wheel, changes to the engaged sprocket on the cassette, and thus the sizes of the engaged rear sprocket, may cause the free zone to change size. During transition of the outer chainring 13 between aligned and unaligned positions, the segment subassemblies A-G may be moved or otherwise transitioned while they are within the free zone. Continued rotation of the crank assembly may then cause each segment subassembly to enter the free zone and to transition from an aligned to unaligned state or position, or vice versa.

Turning now to FIG. 7, an example embodiment of a front shifter is illustrated and described. It should be appreciated that FIG. 7 illustrates only one example front shifter, and that other shifters or other mechanisms may be used. In particular, any suitable mechanism may be used to, for example, cause a chainring to transition between aligned and unaligned positions as described herein.

In FIG. 7, front shifter is illustrated as a modified derailleur that moves an outer chainring 13 instead of moving the chain 16. The front shifter may include a derailleur 21 that may be attached to a bicycle. For instance, the derailleur 21 may include a cavity that allows it to attach directly or indirectly to a frame element of the bicycle (see FIG. 1A), although it may otherwise connect to the bicycle in some other manner. The derailleur 21 may be used to selectively control the operation of the front shifter, and thus also portions of the crank assembly. Accordingly, in at least some embodiments, the derailleur 21 may include one or more control connectors 28. A control connector 28 may, for instance, allow a cable to connect thereto. Such a cable (e.g., a Bowden cable) or other linkage may then connect to a shift lever mounted on a down tube, handlebar stem, handlebar, or other component of a bicycle, or any combination of the foregoing, so as to be selectively actuated by an operator of the bicycle.

For instance, the bicycle operator may actuate a hand control that selectively tensions the cable. The cable may transfer a tensile or compressive force, or changes thereto, to the control connectors 28. Such force may then cause movement of the control connector 28 and/or other mechanical components in the front shifter. In some embodiments, existing hand or other controls may be connected to the control connector 28, such that the front shifter may be retrofit to operate with existing controls. Moreover, in some embodiments, such operation of the front shifter may allow the system to operate in a purely or substantially mechanical manner. The rider of a bicycle may therefore operate the transmission system to change gear ratios without concern that a power source (e.g., batteries) may have failed.

For instance, the illustrated front shifter of FIG. 7 may include an arm mount 22 coupled to the derailleur 21 and/or control connector 28. The arm mount 22 may, in turn, connect to a shifter arm 23. In some embodiments, when a tensile or compressive force is applied to a control connector 28, or when a change in tensile force is detected, the control connector 28 may cause the arm mount 22 and/or shifter arm 23 to move. Such movement may, for instance, be in an axial direction. In some embodiments, for instance, the shifter arm 23 may move an axial distance that generally corresponds to the width of the support plate 12 (see FIG. 2). In some examples, the shifter arm 23 may be positioned between a stop plate 9 and gear segment 2. As the shifter arm 23 moves in an inward axial direction, the shifter arm 23 may engage the gear segment 2 and cause the gear segment 2 to move in an axial direction. In contrast, as the shifter arm 23 moves in an outward axial direction, the shifter arm 23 may engage the stop plate 9, and cause the stop plate to move in an outward axial direction.

With continued reference to FIG. 7, it will also be appreciated that in some embodiments, the shifter arm 23 may directly engage or otherwise cause movement of components in a crank assembly. In other embodiments, however, the shifter arm 23 may include or be attached to other members that directly or otherwise engage or cause movement in the crank assembly. In FIG. 7, for instance, the shifter arm 23 may be attached to a plate 25. The plate 25 has, in the illustrated embodiment, a generally elliptical shape. Such elliptical shape may allow, for instance, the plate 25 to smoothly transition a segment subassembly between alternative states. For instance, a stop plate 9 and/or a gear segment 2 may engage at a distal end of the plate 25. The elliptical shape of the plate 25 may gradually advance the stop plate 9 and/or gear segment 2 in an axial direction, so as to smoothly transition segment subassemblies between aligned and unaligned positions or states, and thus also to smoothly transition the bicycle transmission between gear ratios.

It should be appreciated that the components of the illustrated front shifter may be connected and linked together in any suitable manner. In FIG. 7, for instance, the control connector 28 may be pivotally connected to the derailleur 21 and/or the arm mount 22. The arm mount 22 may also, in some embodiments, have one or more openings that correspond to openings in the shifter arm 23. One or more bolts 26 and/or nuts 24 may be used to connect the shifter arm 23 to the arm mount 22. As such, as the arm mount 22 moves, the shifter arm 23 may experience a corresponding movement or translation. In other embodiments, the arm mount 22 may be substantially stationary. For instance, a guide may be used to, for instance, define a path along which the shifter arm 23 may translate in an axial direction.

The embodiments disclosed herein are merely exemplary and are not intended to limit the scope of the appended claims or other aspects of the disclosure herein. Indeed, other embodiments and aspects of bicycle transmissions, front shifters, crank assemblies, and the like are specifically considered as falling within the scope of the disclosure. For instance, FIGS. 8 and 9 provide additional disclosure of assemblies and components that may minimize lateral forces on an associated chain while producing a gear ratio change.

As shown in FIG. 8, a crank assembly includes multiple angularly offset gear segments 2. While the crank assembly in FIG. 8 includes eight gear segments, it will be understood that substantially any number of gear segments may be used. Each of the gear segments is attached to the crank assembly via a hinge (e.g. hinge 90 in FIG. 9) or other mechanism which allows the gear segments to be rotated about an axis. The hinge allows the gear segment to “rock” or change positions, for example, from a low gear into a high gear. For instance, as shown in FIG. 9, gear segment 2 may rock on hinge 90 between a low gear position and a high gear position (i.e. between low gear prong 91B and high gear prong 91A). The prongs of the gear segment may be appropriately angled to engage the chain in a substantially perpendicular manner. For instance, when the hinged gear segment is locked into the high gear position, prong 91A is in perpendicular alignment with the chain 60. When the gear segment is locked into the low gear position, prong 91B is in perpendicular alignment with the chain. Thus, the gear segments may be hingedly rocked from the low gear position to the high gear position to accomplish a gear ratio change.

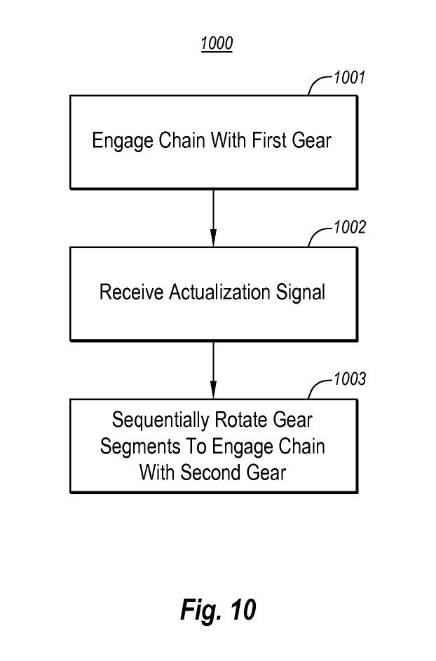

This will be described further below with regard to Method 1000 of FIG. 10. In Method 1000, method step 1001 includes engaging a chain with a first gear of a crank assembly 51. The crank assembly includes multiple angularly offset gear segments 2 that are hingedly connected to the crank assembly. Each gear segment includes one or more sets of prongs. Each set of prongs corresponds to a gear (e.g. high gear 91A or low gear 91B). The first gear and the chain are substantially aligned within a first plane (the first plane being transverse to Axis A). The first gear of the hinged gear segment 2 includes a set of prongs 91a. The first set of prongs 91a is axially offset from the second set of prongs 91B of the second gear of gear segment 2.

Method 1000 of FIG. 10 continues by receiving an actuation signal (e.g. from a shifter) that represents a request for a gear ratio change (e.g. changing from a lower gear to a higher gear) (step 1002). In response to that actuation signal, each angularly offset gear segment 2 is sequentially rotated about its hinge 90. This moves the angularly offset gear segments of the second gear into the first plane, causing the chain to engage the second set of prongs of the second gear rather than the prongs of the first gear (91B). As the chain is now engaged with the second set of prongs (91A), the requested gear ratio change has been accomplished (step 1003).

To shed further light on the gear shifting process, FIGS. 8 and 9 will be explained together. The crank assembly of FIG. 8 rotates about axis A. The chain 60 is moving in a counter-clockwise direction around the crank assembly, and is illustrated as being in the process of shifting from a lower gear to a higher gear (e.g. from prongs 91B to prongs 91A). The hinged, angularly offset gear segments are shown at various positions I-VIII. The gear segment at position I is entirely in the free zone 63 (as explained above). As such, the gear segment in position I is free to be “rocked” or otherwise moved into an appropriate position. In positions IV-VIII, the chain is shown as being in engagement with the lower gear prongs 91B, while in positions II and III, the chain is shows as being in engagement with the higher gear prongs 91A.

As such, FIG. 8 illustrates a scenario where the gear segments at positions II and III have been moved (and locked) into their “high gear” positions. The gear segment at position I is free to be rocked into its high gear position. Thereafter, each gear segment, as the crank assembly is rotated counterclockwise around Axis A, is rocked into its high gear position, such that prongs 91A engage the chain around the arc of chain engagement. Correspondingly, FIG. 9 shows, in a cross-sectional view, the chain 60 engaged at the top by “high gear” prong 91A (in FIG. 8, see corresponding gear segment at position III, with the chain in high gear) and at the bottom by prong 91B (see corresponding gear segment at position VIII with the chain still in low gear). In this manner, a gear ratio change may be accomplished while keeping the chain in substantially the same linear plane.

As will be understood by one skilled in the art, the hinged gear segments may include substantially any number of prongs, to accommodate any number of gears. While the gear segments are shown with two sets of prongs corresponding to high and low gears, various ranges of middle gears may also be used, each having their own corresponding sets of prongs. In cases where multiple gears are used, the crank assembly may include multiple different locked positions. Each of the gear segments may be moved into the appropriate locked position by the front shifter 50. Moreover, in cases where multiple prongs are used, each prong may be appropriately angled, such that when the prong is locked into any one position, the prongs at that position come into perpendicular alignment with the chain. Accordingly, the appropriate angles for each prong set will depend on how many sets of prongs are being used on each hinged gear segment.

Aspects of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1-3. (canceled)

4. The bicycle drive train as recited in claim 2, wherein said first chainring comprises a driving gear when said second chainring is not aligned with said plane, and wherein said second chainring comprises a driving gear when said second chainring is aligned with said plane.

5. The bicycle drive train recited in claim 2, wherein said second chainring comprises a plurality of angularly offset gear segments.

6. The bicycle drive train recited in claim 2, wherein said plane is a first plane and said first chainring is fixed in said first plane, and wherein said second chainring is selectively moveable between said first plane and a second plane, said second plane being axially offset from, and generally parallel to, said first plane.

7. The bicycle drive train recited in claim 5, wherein each of said plurality of angularly offset gear segments is movably attached to said crank assembly.

8. The bicycle drive train recited in claim 2, further comprising a shifter.

9. The bicycle drive train recited in claim 8, wherein said shifter is configured to: in response to a first selective actuation, cause a gear ratio change from a first ratio to a second ratio; and
in response to a second selective actuation, cause a gear ratio change from said second ratio to said first ratio.

10. The bicycle drive train recited in claim 9, wherein:
in response to the first selective actuation, said second chainring is moved from an unaligned position outside said plane to an aligned position within said plane; and
in response to the second selective actuation, said second chainring is moved from the aligned position within said plane to the unaligned position outside said plane.

11. The bicycle drive train recited in claim 9, wherein, in response to the first selective actuation, the shifter sequentially rotates each angularly offset gear segment about a hinge, such that each angularly offset gear segment is sequentially changed from an unaligned position outside said plane to an aligned position within said plane to change the gear ratio from the first ratio the second ratio.

12. The bicycle drive train recited in claim 11, wherein each angularly offset gear segment is locked into place upon being hingedly rotated by said shifter.

13. The bicycle drive train recited in claim 2, further comprising a third chainring having a third gear size, said third chainring being adapted to selectively move into and out of alignment with said plane to selectively change a gear ratio within said plane.

14. A bicycle transmission, comprising:
a first chainring, wherein said first chainring is fixedly aligned in a first plane and has a plurality of teeth configured to engage links of a chain;
a second chainring, wherein said second chainring is selectively aligned in a second plane that is generally parallel to said first plane and has a plurality of angularly offset gear segments that are movably attached to a crank assembly, each of said plurality of segments having one or more teeth configured to engage said links of said chain, said first and second chainrings being of different sizes; and
a shifter proximate at least said second chainring, wherein said shifter is configured to selectively move one or more of said plurality of angularly offset gear segments of said second chainring independent of one or more other of said plurality of angularly offset gear segments of said second chainring, wherein said shifter is configured to selectively move said one or more of said plurality of angularly offset gear segments from said second plane to said first plane, such that said chain is transferred from said first chainring to said second chainring while remaining in substantially the same plane.

15. The bicycle transmission of claim 14, further comprising:
a support member, wherein said support member is fixed at an axial location offset from said first chainring, and wherein said second chainring is configured to translate axially a distance generally corresponding to a thickness of said support member.

16. The bicycle transmission of claim 14, wherein said second chainring is larger than said first chainring, and wherein said plurality of angularly offset gear segments of said second chainring are sized such that said first chainring does not substantially interfere with movement of said plurality of said segments into said first plane.

17. The bicycle transmission of claim 14, wherein each angularly offset gear segment comprises a plurality of prongs, wherein each of said prongs is configured to engage said links of said chain.

18. The bicycle transmission of claim 17, wherein said prongs comprise angled ends of varying degrees, each prong being angled perpendicular to said chain links, such that upon being moved from said second plane to said first plane, each prong of said angularly offset gear segment is in perpendicular alignment with said chain links.

19. The bicycle transmission of claim 14, further comprising a third chainring, wherein said third chainring is selectively aligned in said second plane and has a plurality of angularly offset gear segments that are movably attached to said crank assembly, each of said plurality of segments having one or more teeth configured to engage said links of said chain, said third chainring being of a different size than said first and second chainrings.

20. The bicycle transmission of claim 19, wherein said shifter is configured to selectively move one or more of said plurality of angularly offset gear segments of said third chainring independent of one or more other of said plurality of angularly offset gear segments of said third chainring, wherein said shifter is configured to selectively move said one or more of said plurality of angularly offset gear segments of said third chainring from said second plane to said first plane, such that said chain is transferred from said first chainring or said second chainring to said third chainring while remaining in substantially the same plane.

21. An apparatus for changing a gear ratio, comprising:
a crank assembly configured to rotate about an axis to drive a chain within a first plane;
a plurality of angularly offset gear segments connected to the crank assembly, each angularly offset gear segment having at least one low gear prong and at least one high gear prong that are axially offset from one another, each of the plurality of angularly offset gear segments being rotatable to selectively move the at least one low gear prong and the at least one high gear prong into and out of the first plane, wherein the apparatus defines a first gear ratio when the low gear prongs from plurality of angularly offset gear segments are rotated into the first plane, and wherein the apparatus defines a second gear ratio when the high gear prongs from plurality of angularly offset gear segments are rotated into the first plane.

22. The apparatus recited in claim 21, further comprising a shifter arm that receives an actuation signal, the actuation signal representing a request for a gear ratio change, and in response to the actuation signal, sequentially rotates each angularly offset gear segment, thereby moving the low gear prongs and the high gear prongs into or out of the first plane, causing the chain to transition between the low and high prongs while the chain remains in the first plane, thereby producing the requested gear ratio change.

23. The apparatus recited in claim 22, wherein said actuation signal comprises a received change in cable tension.

24. The apparatus recited in claim 21, wherein the high gear prongs are maintained in the first plane using a biasing force.

25. The apparatus recited in claim 21, wherein the high gear prongs extend radially further away from the axis about which the crank assembly rotates than the low gear prongs.

26. The apparatus recited in claim 21, wherein each angularly offset gear segment further comprises at least one intermediate gear prong that is axially offset from the at least one low gear prong and at least one high gear prong, each of the plurality of angularly offset gear segments being rotatable to selectively move the at least one intermediate gear prong into and out of the first plane, wherein the apparatus defines a third gear ratio when the intermediate gear prongs from plurality of angularly offset gear segments are rotated into the first plane.
